(19) United States
(12) Patent Application Publication
(10) Pub. No.: US 2008/0034595 A1
(43) Pub. Date: Feb. 14, 2008

(54) Cutter wheel for cutting glass

(76) Inventor: Asako Arai, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 11/882,564

(22) Filed: Aug. 2, 2007

(30) Foreign Application Priority Data
Aug. 10, 2006 (JP) 2006-218174

(51) Int. Cl. B26B 9/00; C03B 33/10

(52) U.S. Cl. 30/347

(57) ABSTRACT

A glass cutter wheel includes a wheel body having a pair of inclined surfaces defining an annular cutting edge therebetween and extending obliquely radially inwardly from the cutting edge to the respective side surfaces of the wheel body. Each inclined surfaces is formed with ground lines that are spaced from the cutting edge by a distance of 2 to 100 μm. Because the cutting edge penetrates into a glass material by a distance of 3 to 7 μm without the need to form ribs on the cutting edge, the ground lines serve to form a large number of vertical cracks. This completely prevents discontinuous cutting lines and chipping of the glass material at intersections of cutting lines, and also serves to provide smooth cut surfaces, thereby increasing the breaking strength.

### BACKGROUND OF THE INVENTION

This invention relates to a cutter wheel for cutting glass materials by forming cutting lines in glass materials.

A cutter wheel for cutting glass materials is rotatably mounted on a glass cutting machine or tool to cut a glass material by forming a cutting line in the surface of the glass material. Such a cutter wheel includes a wheel body having a pair of inclined surfaces on the outer periphery thereof that are inclined in opposite directions from the diametrical central plane of the wheel body toward its side surfaces. The pair of inclined surfaces intersect each other on the diametrical central plane of the wheel body to define an annular cutting edge therebetween. Such wheel cutters are mainly made of cemented carbide or sintered diamond Compax.

A cutter wheel made of cemented carbide has a Vickers hardness Hv of 2000. If a diamond grinder is used to grind such a cutter wheel to form the cutting edge, ground lines that are complementary to the mesh of the diamond grinder are formed in the respective inclined surfaces. Such ground lines extend over the entire width of the inclined surfaces from the cutting edge to the respective side surfaces of the wheel body (see JP patent publication 6-56451A).

On the other hand, a cutter wheel made of sintered diamond Compax has a Vickers hardness Hv of 8000 to 10000. Thus no ground lines are formed by an ordinary diamond grinder for forming a cutting edge. Instead, the inclined surfaces are finished like satin from the cutting edge to the side surfaces.

Today's glass sheets used for electronic devices and their peripherals, such as liquid crystal panels, are typically harder and thinner than before. In order to cut such a glass sheet with a cutter wheel made of cemented carbide, because such a cutter wheel is not sufficiently high in hardness, the cutting edge has to be finished to a rough surface by grinding.

By finishing the cutting edge to a rough surface by grinding, the cutting edge can more easily engage and bite into glass materials, so that it is possible to easily form a cutting line even in a hard glass material. But when a glass material is cut, vertical cracks (rib marks) formed in the cut surfaces tend to be rough corresponding to the rough cutting edge. This impairs the breaking strength of the glass.

On the other hand, a cutter wheel made of sintered diamond Compax is high in hardness, so that its cutting edge can easily engage and bite into glass materials. But because no ground lines are formed in the inclined surfaces so as to extend from the cutting edge to the side surfaces, discontinuous cutting lines tend to be formed.

In particular, when two cutting lines are formed so as to cross each other, these cutting lines tend to be discontinuous at the junction thereof.

If two cutting lines that cross each other are discontinuous at their junction, the yield during the subsequent breaking step tends to be low. Also, the breaking strength of the thus cut glass sheets tends to be low.

An object of the present invention is to provide a cutter wheel which can form continuous cutting lines in a glass material and thus does not impair the breaking strength of the glass material after being cut.

### SUMMARY OF THE INVENTION

In order to achieve this object, the present invention provides a glass cutter wheel comprising a wheel body having side surfaces and an outer peripheral surface through which the side surfaces are connected together, the outer peripheral surface comprising a pair of inclined surfaces defining an annular cutting edge therebetween and extending obliquely radially inwardly from the cutting edge to the respective side surfaces, each of the inclined surfaces being formed with ground lines that are spaced from the cutting edge.

The ground lines may be spaced from the cutting edge by a distance of 2 to 100 μm, and/or may be 1 to 30 μm deep. Further, the ground lines formed in each of the inclined surfaces may be circumferentially spaced from each other by a distance of 30 to 500 μm.

The ground lines may be arranged such that imaginary extensions of the ground lines formed in each of the inclined surfaces intersect the cutting edge at points between adjacent points at which the imaginary extensions of the ground lines formed in the other of the inclined surfaces intersect the cutting edge. Otherwise, they may be arranged such that imaginary extensions of the ground lines formed in each of the inclined surfaces intersect the respective imaginary extensions of the ground lines formed in the other of the inclined surfaces on the cutting edge.

By providing the ground lines so as to be spaced from the cutting edge by a distance of 2 to 100 μm, smooth surfaces are formed between the cutting edge and the ground lines in the respective inclined surfaces. With this arrangement, when a glass material is cut using this cutter wheel, the smooth surfaces serve to suppress damage to the glass material at its contact surfaces to the depth of cut of 3 to 7 μm. The ground lines serve to promote the growth of cracks in the direction perpendicular to the surface of the glass material, thereby providing smooth and clear cut surfaces. The glass material can thus be broken extremely easily along the cutting line.

The ground lines can be formed by electrochemical grinding. Such ground lines can be formed easily using a straight type rotary electrode comprising a plurality of nonconductive discs and a plurality of conductive metallic electrode sheets that are disposed between the adjacent discs.

By providing the ground lines so as to be spaced from the cutting edge, smooth surfaces are formed between the cutting edge and the ground lines in the respective inclined surfaces. With this arrangement, when a glass material is cut using this cutter wheel, the smooth surfaces serve to suppress damage to the glass material at its contact surfaces. Thus, smooth cut surfaces are obtained. The ground lines serve to prevent formation of discontinuous cutting lines and promote the growth of cracks in the direction perpendicular to the surface of the glass material, thereby providing smooth and clear cut surfaces. The glass material can thus be broken extremely easily along the cutting line. This markedly improves the yield of cutting of glass materials.

### BRIEF DESCRIPTION OF THE DRAWINGS

Other features and objects of the present invention will become apparent from the following description made with reference to the accompanying drawings, in which:

FIGS. 1A, 1B and 1C are front views of cutter wheels embodying the present invention;

FIGS. 2A and 2B are a vertical sectional view and a plan view of a cutter wheel according to the present invention, showing how ground lines are formed in the inclined surfaces of the cutter wheel by electrochemical grinding;

FIG. 3A is a sectional view of a glass material cut by the cutter wheel according to the present invention; and

FIG. 3B is a sectional view of a glass material cut by a conventional cutter wheel.

### DETAILED DESCRIPTION OF THE PREFERRED EMBODIMENTS

The embodiment is now described with reference to the drawings.

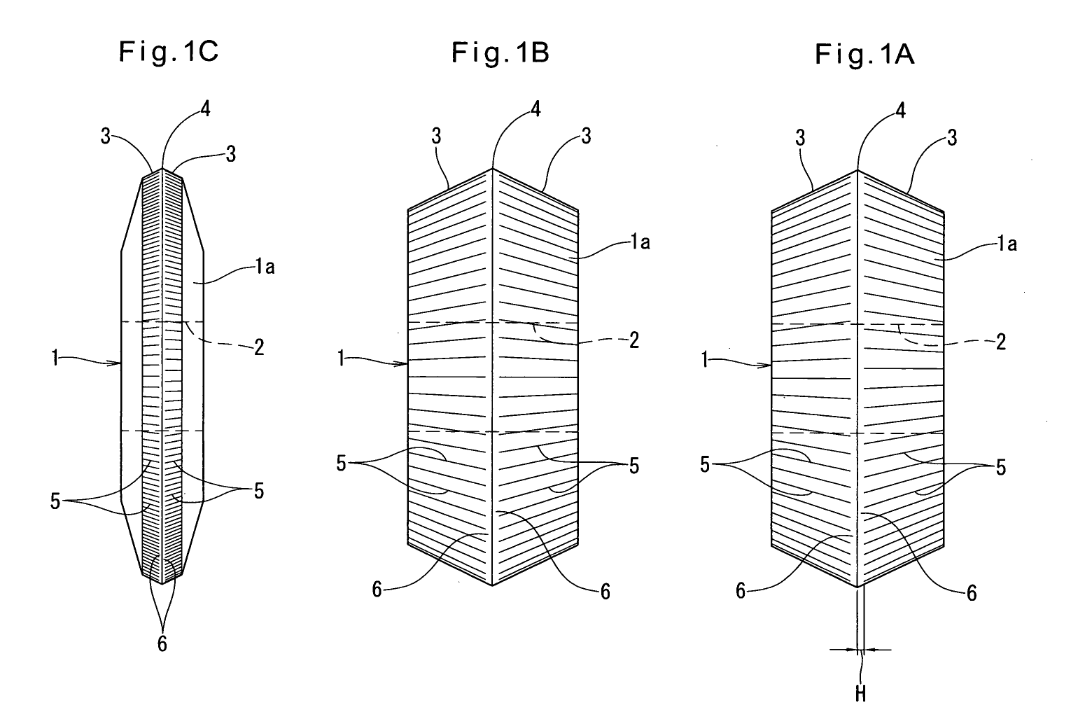

As shown in FIG. 1, the cutter wheel 1 for cutting glass materials according to the present invention comprises a disk-shaped wheel body 1a having a radially outer periphery comprising a pair of inclined surfaces 3 on both sides of the diametric central plane of the wheel body 1a and inclined radially inwardly therefrom toward its side surfaces, respectively. An annular cutting edge 4 is defined at the intersection of the inclined surfaces 3. In each of the inclined surfaces 3, lines 5 are formed by grinding (such lines 5 are hereinafter simply referred to as “ground lines”). The ground lines 5 are spaced from the cutting edge 4.

The wheel body 1a may be made of sintered diamond Compax or cemented carbide. The wheel body 1a has a maximum diameter of 2 mm to 6 mm, and an axial thickness of 0.3 mm to 1.5 mm. The inclined surfaces 3 form an angle of 90 to 160 degrees, preferably 130 degrees, relative to each other.

The ground lines 5 formed on the inclined surfaces 3 are spaced from the cutting edge 4 by a distance H of 2 to 100 μm, have a depth of 1 to 30 μm, have openings having a width of about 40 μm, and are circumferentially spaced from each other by a distance of 30 to 500 μm.

Because the ground lines 5 are spaced from the cutting edge 4, a smooth surface 6 having a width H is formed on each inclined surface 3 between the cutting edge 4 and the ends of the ground lines 5.

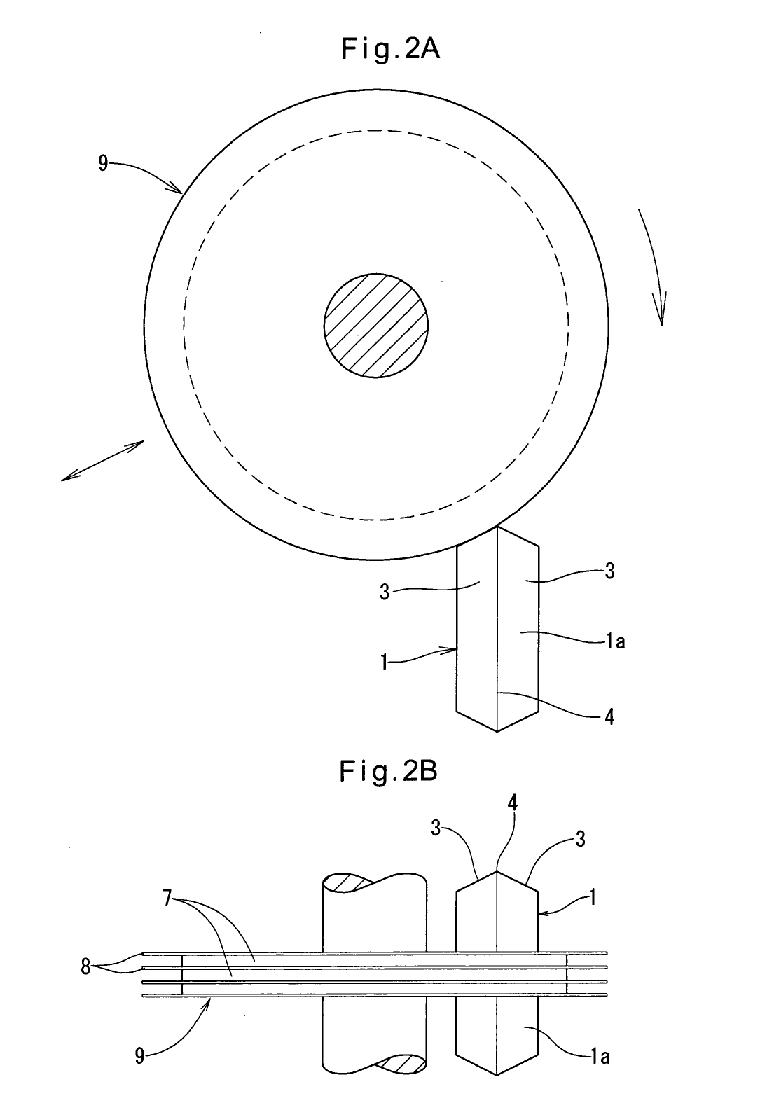

The ground lines 5 can be formed by electrochemical grinding, in which a straight type rotary electrode 9 is used having a multilayer structure comprising a plurality of nonconductive discs 7 and a plurality of conductive metallic electrode sheets 8 that are disposed between the adjacent discs 7. Specifically, as shown in FIGS. 2A and 2B, the rotary electrode 9 is rotated with a current passed through the conductive electrode sheets 8, and the peripheral edges of the conductive electrode sheets 8 are brought into contact with each of the inclined surfaces 3 of the wheel body 1a, while intermittently rotating the wheel body 1a to form straight, radial ground lines 5 that are circumferentially spaced from each other at predetermined intervals. In the figures, the ratios of the diameter and thickness of the wheel body 1a to the various dimensions of the ground lines 5 and the rotary electrode 9 do not correspond to the various numerical values indicated throughout the description to facilitate understanding of the present invention.

The conductive electrode sheets 8 of the rotary electrode 9 each have a thickness of 40 μm, and a diameter of about 50 mm to 150 mm, and are spaced from the adjacent sheets 8 by 30 to 500 μm by the discs 7.

The ground lines 5 shown in FIG. 1A are arranged such that the imaginary extensions of the lines 5 in each of the inclined surfaces 3 intersect the cutting edge 4 at points circumferentially alternating with the points at which the imaginary extensions of the lines 5 in the other of the inclined surfaces 3 intersect the cutting edge 4.

The ground lines 5 shown in FIG. 1B are arranged such that the imaginary extensions of the lines 5 in one of the inclined surfaces 3 intersect the imaginary extensions of the respective lines 5 in the other of the inclined surfaces 3 on the cutting edge 4. In either case, the ground lines 5 may extend to or terminate short of the respective side surfaces of the wheel body 1a as shown in FIG. 1C. In the embodiment of FIG. 1C, each inclined surface 3 comprises two areas having different inclination angles, and the ground lines 5 are formed in one of the two areas that is adjacent to the cutting edge 4.

The cutter wheel 1 for cutting glass materials according to the present invention is mounted on a shaft of a glass cutting machine or tool by inserting the shaft into a shaft hole 2 formed in the cutter wheel 1. A cutting line is formed in a glass material by pressing the cutting edge 4 against the surface of the glass material and moving one of the cutter wheel 1 and the glass material relative to the other, thereby rotating the cutter wheel 1. The glass material is then cut by separating its portions on both sides of the cutting line from each other.

The inclined surfaces 3 are formed smoothly by grinding the outer periphery of the wheel body 1a, thereby defining the cutting edge 4 therebetween. Thereafter, the ground lines 5 are formed by the rotary electrode 9 as shown in the drawings.

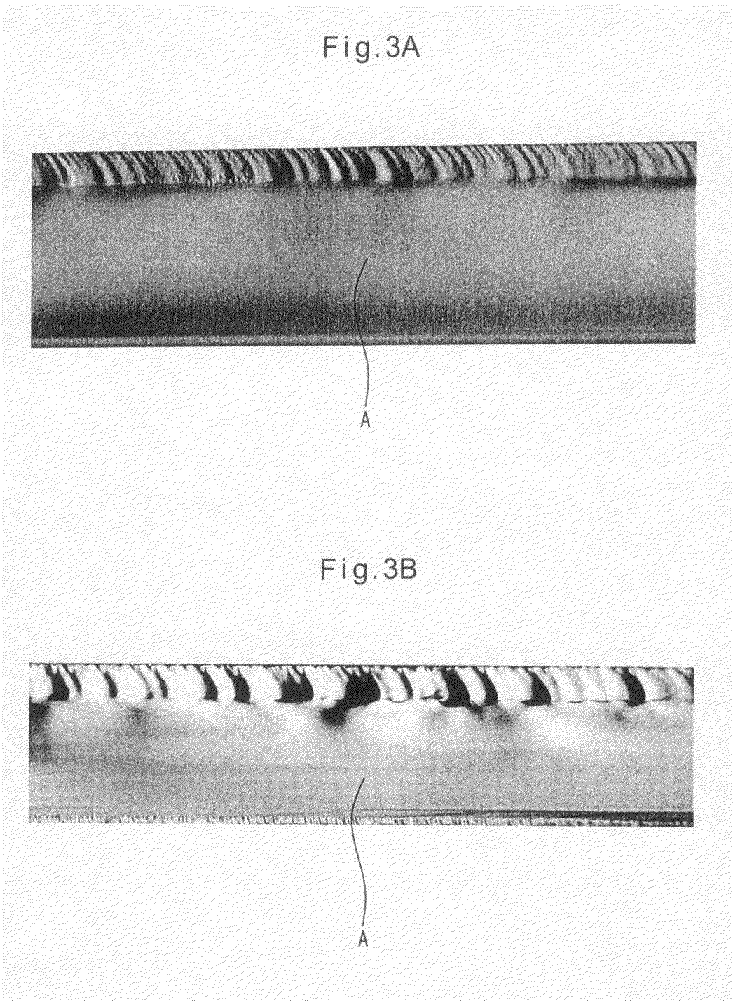

Because the smooth surfaces 6 having a width H of 2 to 100 μm are formed between the cutting edge 4 and the ends of the ground lines 5, when the cutting edge 4 cuts into a glass material, the smooth surfaces 6 serve to reduce the damage to the glass material at the contact surface within the range of the depth of cut of 3 to 7 μm. The ground lines 5 serve to prevent discontinuous cutting lines and chipping of the glass material at the intersections of cutting lines. Thus, it is possible to form continuous cutting lines in the glass material. Further, the ground lines 5 promotes the growth of cracks in the direction perpendicular to the surface of the glass material. Thus, as shown in FIG. 3A, the cut surfaces of the glass material A formed by breaking the glass material along the cutting lines are smoother than conventional cut surfaces shown in FIG. 3B. Therefore, the cutter wheel according to the present invention can be advantageously used for cutting liquid crystal panels for which high breaking strength is required such as for use in cell phones and portable game machines.

By promoting the growth of cracks perpendicular to the surface of the glass material, the glass material can be broken extremely easily, so that the yield of breaking glass materials improves remarkably.

What is claimed is:

1. A glass cutter wheel comprising a wheel body having side surfaces and an outer peripheral surface through which said side surfaces are connected together, said outer peripheral surface comprising a pair of inclined surfaces defining an annular cutting edge therebetween and extending obliquely radially inwardly from said cutting edge to the respective side surfaces, each of said inclined surfaces being formed with ground lines that are spaced from said cutting edge.

2. The glass cutter wheel of claim 1 wherein said ground lines are spaced from said cutting edge by a distance of 2 to 100 μm.

3. The glass cutter wheel of claim 1 wherein said ground lines are 1 to 30 μm deep.

4. The glass cutter wheel of claim 1 wherein said ground lines are arranged such that imaginary extensions of said ground lines formed in each of said inclined surfaces intersect said cutting edge at points between adjacent points at which the imaginary extensions of said ground lines formed in the other of said inclined surfaces intersect said cutting edge.

5. The glass cutter wheel of claim 1 wherein said ground lines are arranged such that imaginary extensions of said ground lines formed in each of said inclined surfaces intersect the respective imaginary extensions of said ground lines formed in the other of said inclined surfaces on said cutting edge.

6. The glass cutter wheel of claim 1 wherein said ground lines formed in each of said inclined surfaces are circumferentially spaced from each other by a distance of 30 to 500 μm.
